(19) United States
(12) Patent Application Publication
(10) Pub. No.: US 2014/0372291 A1
(43) Pub. Date: Dec. 18, 2014

(54) MULTI-PARTY TRANSACTION PAYMENT NETWORK BRIDGE APPARATUS AND METHOD

(71) Applicant: MASTERCARD INTERNATIONAL INCORPORATED, Purchase, NY (US)

(72) Inventors: Paul Michael MUSSER, Pilot Hill, CA (US); David Aaron LASKIN, Purchase, NY (US)

(21) Appl. No.: 14/308,400

(22) Filed: Jun. 18, 2014

Related U.S. Application Data
(60) Provisional application No. 61/836,588, filed on Jun. 18, 2013.

(51) Int. Cl. G06Q 20/10

(52) U.S. Cl. CPC G06Q 20/10
USPC 705/39

(57) ABSTRACT

A system, method, and computer-readable storage medium configured to process financial transactions that traverse an NGO network with an interbank network.

### RELATED APPLICATIONS

This application claims priority to provisional U.S. Patent Application Ser. No. 61/836,588, entitled “Multi-Party Transaction Payment Network Bridge Apparatus and Method,” filed on Jun. 18, 2013.

### BACKGROUND

1. Field of the Disclosure

Aspects of the disclosure relate in general to financial services. Aspects include an apparatus, system, method and computer-readable storage medium to process financial transactions that traverse a non-governmental organization (NGO) network with an interbank network.

2. Description of the Related Art

In the non-developed world, when a natural disaster or other calamity occurs, non-governmental organizations (NGOs) come and deliver aid to the stricken area. Traditionally, aid has come in the form of food, shelter, medicine, and other types of goods and services. However, distributing aid is a difficult logistical task and can lead into undesired consequences. Distributing aid vouchers may lead to voucher counterfeiting or theft of the voucher. Moving tons of free food into a stricken area may, for example, may put local farmers and merchants out of business, and damage local market economies.

More recently, non-governmental organizations have attempted to bolster local economies by distributing currency to victims. For centuries, financial transactions have used currency, such as banknotes and coins. In modern times, however, payment cards are rapidly replacing cash to facilitate payments. NGOs have attempted to use the security of payment cards by distributing aid as money or other stored value on a payment card. In such an system 1000, shown in FIG. 1, an NGO 1200 creates a closed-loop payment network 1100 (“NGO network”) among merchants 1110a-c in the stricken area. In some instances, automated teller machines (ATMs) 1120a-c may also be deployed in the stricken area.

An NGO payment network server 1300 processes transactions for goods and services on the NGO network 1100. Payment cards issued by the NGO are limited to participating merchants 1110 on the NGO network 1100. Similarly, a consumer using a payment card issued by a financial institution will not be able to user their payment card on the NGO network 1100.

### SUMMARY

Embodiments include a system, device, method and computer-readable medium that link payment networks.

Embodiments include a method of processing a financial transaction. The method comprises receiving the financial transaction via a network interface. The financial transaction contains a cardholder identifier, a merchant identifier, a transaction type identifier, and a transaction amount. A processor identifies that the financial transaction is a cross-network transaction from either a non-governmental organization (NGO) network to an interbank network or the interbank network to the NGO network. The identification by comparing the cardholder identifier and the merchant identifier. The processor retrieves a cross-network interface rule from a non-transitory computer-readable storage medium. The retrieval is based at least in part on the cardholder identifier, the merchant identifier and the transaction type identifier. The processor determines whether the financial transaction is permitted by the cross-network interface rule. The network interface transmits a transaction decline when the financial transaction is not permitted by the cross-network interface rule.

An apparatus embodiment processes a financial transaction. The apparatus comprising a network interface and a processor. The network interface is configured to receive the financial transaction. The financial transaction contains: a cardholder identifier, a merchant identifier, a transaction type identifier, and a transaction amount. The processor is configured to identify that the financial transaction is a cross-network transaction from either a non-governmental organization (NGO) network to an interbank network or the interbank network to the NGO network. The identification occurs by comparing the cardholder identifier and the merchant identifier. The processor retrieves a cross-network interface rule from a non-transitory computer-readable storage medium. The retrieval is based at least in part on the cardholder identifier, the merchant identifier and the transaction type identifier. The processor determines whether the financial transaction is permitted by the cross-network interface rule. When the financial transaction is not permitted by the cross-network interface rule, the network interface is further configured to transmit a transaction decline.

A non-transitory computer-readable storage medium embodiment is encoded with data and instructions. When the instructions are executed by a computing device, causes the computing device to process a financial transaction. A network interface receives the financial transaction. The financial transaction contains a cardholder identifier, a merchant identifier, a transaction type identifier, and a transaction amount. A processor identifies that the financial transaction is a cross-network transaction from either a non-governmental organization (NGO) network to an interbank network or the interbank network to the NGO network. The identification by comparing the cardholder identifier and the merchant identifier. The processor retrieves a cross-network interface rule from the non-transitory computer-readable storage medium. The retrieval is based at least in part on the cardholder identifier, the merchant identifier and the transaction type identifier. The processor determines whether the financial transaction is permitted by the cross-network interface rule. The network interface transmits a transaction decline when the financial transaction is not permitted by the cross-network interface rule.

### BRIEF DESCRIPTION OF THE DRAWINGS

FIG. 1 illustrates a NGO network system of the PRIOR ART.

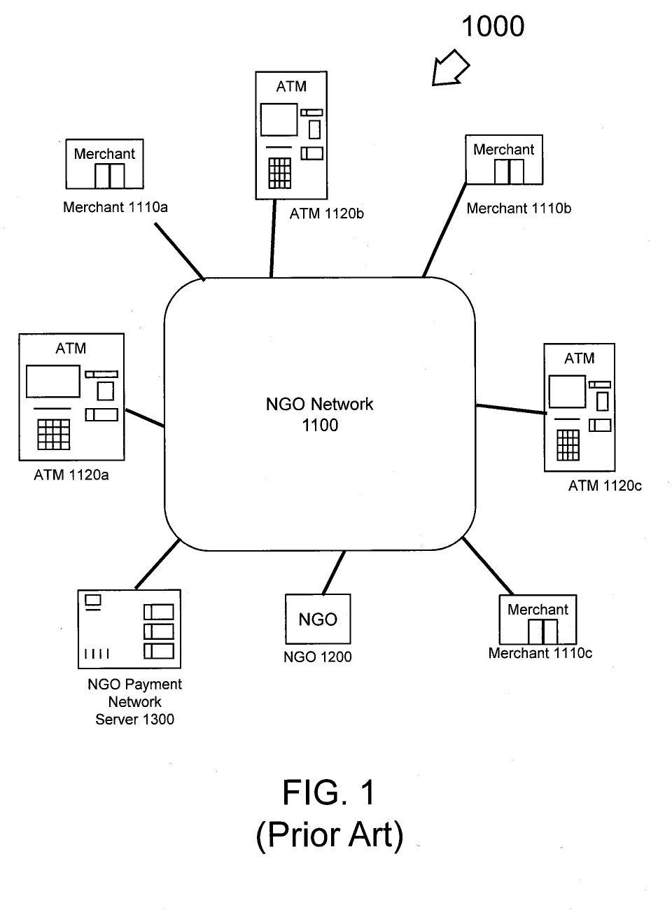

FIG. 2 depicts a system to process financial transactions that traverse an NGO network with an interbank network.

FIG. 3 is a block diagram of a payment network bridge configured to process financial transactions that traverse an NGO network with an interbank network.

FIG. 4 is a flow chart of a method of performing a financial transaction that crosses the NGO network with the interbank network.

### DETAILED DESCRIPTION

One aspect of the disclosure includes the realization that in some cases, an aid recipient may be mobile, and may travel as a refugee or visitor to areas not covered by a closed-loop NGO network. In such an instance, it would be useful for the aid recipient to be able to access funds or services at a merchant that is not connected to the NGO network.

Yet another aspect of the disclosure includes the understanding that a traveler from the developed world visiting an area covered by the NGO network may not be able to make payments at NGO-approved merchants using a standard payment card that uses an interbank network.

Another aspect of the disclosure includes the realization that a payment network bridge may be used to link an NGO payment network with an interbank network.

In another aspect of the disclosure, a payment network bridge may be used to facilitate secure financial transactions between an NGO payment network and an interbank network.

These and other aspects may be apparent in hindsight to one of ordinary skill in the art.

Embodiments of the present disclosure include a system, method, and computer-readable storage medium configured to enable an immediate online credit refund transaction.

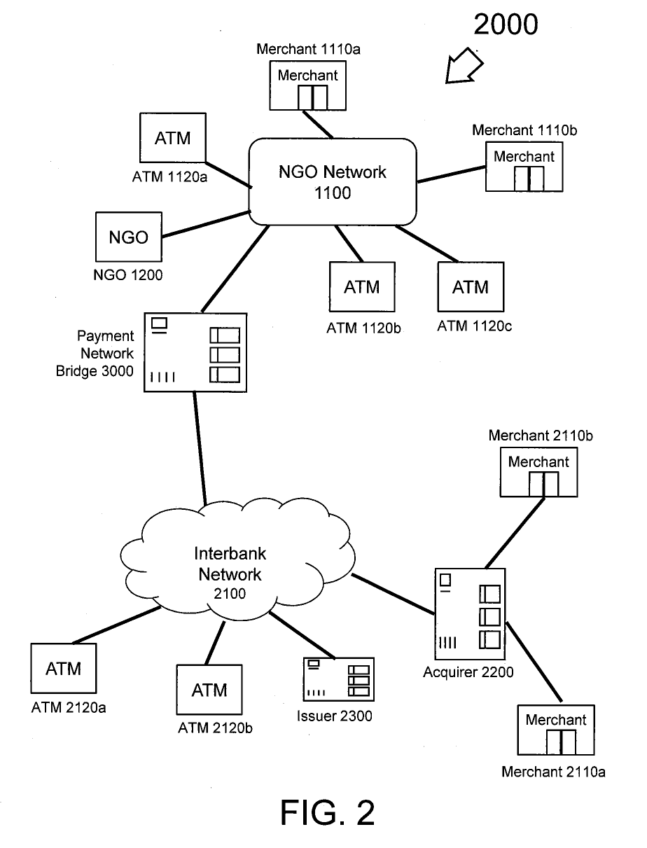

FIG. 2 depicts a system 2000 to link an NGO network 1100 with an interbank network 2100 via a payment network bridge 3000, constructed and operative in accordance with an embodiment of the present disclosure. In such an embodiment, a non-governmental organization 1200 may distribute NGO-issued payment cards to aid recipients for use at NGO-approved merchants 1110a-b, and ATMs 1120a-c. Transactions that take place within entities connected to the NGO network 1100 are processed by payment network bridge 3000.

In parallel, payment network bridge 3000 also processes financial transactions on an interbank network 2100, where payment card acquirer financial institutions 2200 (“acquirer”) and issuer financial institutions 2300 (“issuer”) may be connected.

Payment network bridge 3000 is a payment network capable of processing payments electronically over NGO network 1100 and interbank network 2100. An example payment network includes MasterCard International Incorporated of Purchase, New York. Payment network bridge 3000 may analyze and score financial transactions for the probability of fraud. The transaction scores may be expressed as a probability of fraud from zero (entirely fraudulent) to one (100% chance of no fraud), or scored between zero (fraudulent) and 1,000 (100% not fraudulent).

An acquirer 2200 is a bank, credit union, or other financial institution configured to process transaction data from merchants 2110a-b and prepares authorization formatted data for the payment network bridge 3000.

An issuer 2300 is the bank, credit union, or other financial institution that provides the credit for the financial payment transaction. Issuer 2300 processes data (authorization requests), forwarded from the acquirer 2200 by interbank network 2100, and prepares the authorization formatted response (approvals/declines).

In addition, automated teller machines 2120a-b may also be coupled to interbank network 2100.

As described below, because payment network bridge 3000 processes financial transactions on NGO network 1100 and interbank network 2100, it may process transactions that bridge both networks.

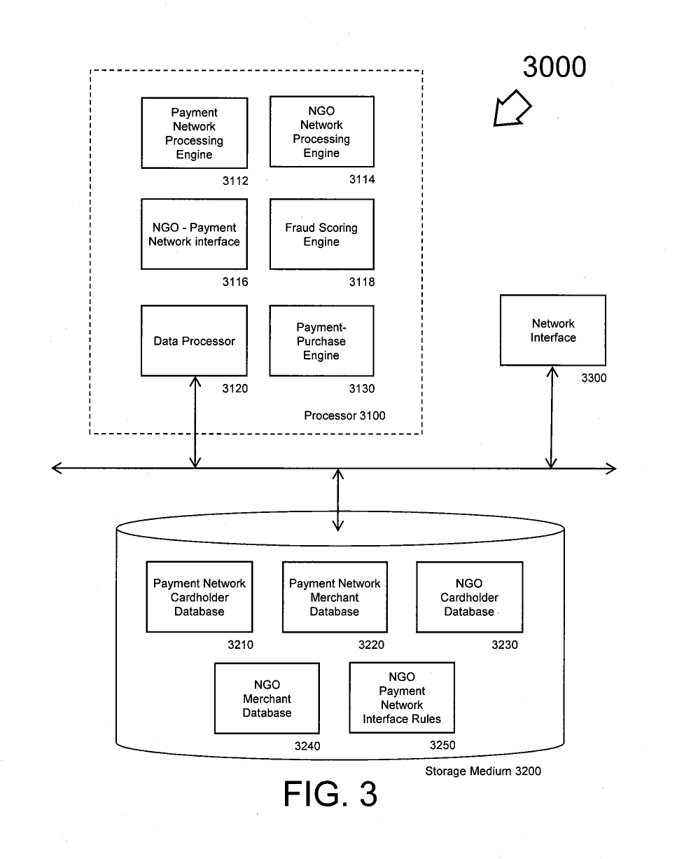

Embodiments will now be disclosed with reference to a block diagram of an exemplary payment network bridge 3000 of FIG. 3 configured to process financial transactions that traverse an NGO network with an interbank network, constructed and operative in accordance with an embodiment of the present disclosure.

Payment network bridge 3000 may run a multi-tasking operating system (OS) and include at least one processor or central processing unit (CPU) 3100, a non-transitory computer-readable storage medium 3200, and a network interface 3300.

Processor 3100 may be any central processing unit, microprocessor, micro-controller, computational device or circuit known in the art. It is understood that processor 3100 may communicate with and temporarily store information in Random Access Memory (RAM) (not shown).

As shown in FIG. 3, processor 3100 is functionally comprised of a payment network processing engine 3112, NGO network processing engine 3114, NGO-payment network interface 3116, a fraud scoring engine 3118, a payment purchase engine 3130, and a data processor 3120.

Payment network processing engine 3112 is the structure that enables the payment network bridge 3000 to communicate with and process data and/or transactions via the interbank network 2100, including from acquirer 2200 and issuer 2300.

NGO network processing engine 3114 is any structure that enables the payment network bridge 3000 to communicate with and process data and/or transactions via the NGO network 1100, including from merchants 1110, ATMs 1120, and the non-governmental organization 1200.

NGO-payment network interface 3116 the structure that allows payment network processing engine 3112 and NGO network processing engine 3114 to communicate with each other. NGO-payment network interface 3116 may apply a set of rules that govern the types of transactions that may occur between payment network processing engine 3112 and NGO network processing engine 3114. These rules may be referred to as NGO-payment network interface rules 3250.

Fraud scoring engine 3118 is a structure that scores financial transactions from payment network processing engine 3112 and/or NGO network processing engine 3114 for fraud. Fraud scoring engine 3118 may use decision tree logic, association rule learning, neural networks, inductive logic programming, support vector machines, clustering, Bayesian networks, reinforcement learning, representation learning, similarity and metric learning, spare dictionary learning, and ensemble methods such as random forest, boosting, bagging, and rule ensembles, or a combination thereof.

Payment-purchase engine 3130 may be any structure that facilitates payment from customer accounts at an issuer 2300, or NGO 1200 to a ATM 1120/2120 or merchant 1110/2110. The customer accounts may include payment card accounts, checking accounts, savings accounts and the like.

Data processor 3120 enables processor 3100 to interface with storage medium 3200, network interface 3300 or any other component not on the processor 3100. The data processor 3120 enables processor 3100 to locate data on, read data from, and write data to these components.

These structures may be implemented as hardware, firmware, or software encoded on a computer readable medium, such as storage medium 3200. Further details of these components are described with their relation to method embodiments below.

Network interface 3300 may be any data port as is known in the art for interfacing, communicating or transferring data across a computer network, examples of such networks include Transmission Control Protocol/Internet Protocol (TCP/IP), Ethernet, Fiber Distributed Data Interface (FDDI), token bus, or token ring networks. Network interface 3300 allows payment network bridge 3000 to communicate with vendors, cardholders, and/or issuer financial institutions.

Computer-readable storage medium 3200 may be a conventional read/write memory such as a magnetic disk drive, floppy disk drive, optical drive, compact-disk read-only-memory (CD-ROM) drive, digital versatile disk (DVD) drive, high definition digital versatile disk (HD-DVD) drive, Blu-ray disc drive, magneto-optical drive, optical drive, flash memory, memory stick, transistor-based memory, magnetic tape or other computer-readable memory device as is known in the art for storing and retrieving data. Significantly, computer-readable storage medium 3200 may be remotely located from processor 3100, and be connected to processor 3100 via a network such as a local area network (LAN), a wide area network (WAN), or the Internet.

In addition, as shown in FIG. 3, storage medium 3200 may also contain a payment network cardholder database 3210, payment network merchant database 3220, NGO cardholder database 3230, NGO merchant database 3240, and NGO payment network interface rules 3250. Payment network cardholder database 3210 is configured to store payment cardholder information, such as payment card and account information, transaction information related to cardholder accounts, and any other payment cardholder-related information. Payment network merchant database 3220 is configured to store merchant information, such as merchant account information. A NGO cardholder database 3230 is configured to store NGO payment cardholder information, such as NGO payment card and account information, NGO transaction information related to NGO cardholder accounts, and any other NGO payment cardholder-related information. NGO merchant database 3240 is configured to store NGO-approved merchant information, such as their account information. As described above, NGO-payment network interface rules 3250 include a set of rules and restrictions that govern the types of transactions that may occur between payment network processing engine 3112 and NGO network processing engine 3114 (“cross-network interface rules”). For illustrative purposes only, example NGO-payment network interface rules 3250 may include limitations on the types of merchants that an NGO-aid-recipient may pay outside the NGO network 1100; for example, the NGO-aid recipient may be restricted to purchases of food or temporary shelter. Another example limitation may include the amount of cash that an NGO-aid-recipient may withdraw from an ATM 2120 outside the NGO network 1100.

These structures may be implemented as hardware, firmware, or software encoded on a non-transitory computer readable medium, such as storage media. Further details of these components are described with their relation to method embodiments below.

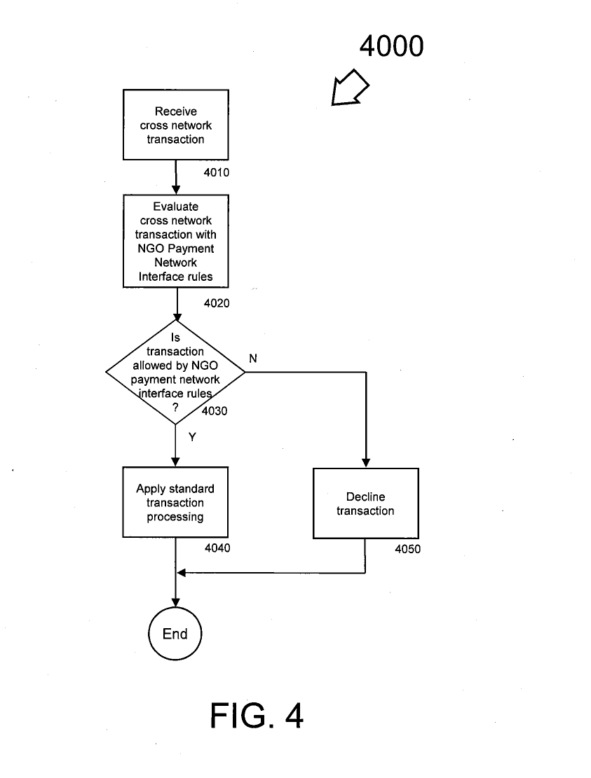

It is understood by those familiar with the art that one or more of these databases 3210-3250 may be combined in a myriad of combinations. The function of these structures may best be understood with respect to the data flow diagram of FIG. 4, as described below.

We now turn our attention to the method or process embodiments of the present disclosure described in the flow chart of FIG. 4. It is understood by those known in the art that instructions for such method embodiments may be stored on their respective computer-readable memory and executed by their respective processors. It is understood by those skilled in the art that other equivalent implementations can exist without departing from the spirit or claims of the invention.

FIG. 4 is a flow chart of a method 4000 of performing a financial transaction that crosses the NGO network 1100 with the interbank network 2100, constructed and operative in accordance with an embodiment of the present disclosure. A cross network transaction is any transaction that occurs from an NGO network 1100 to an interbank network 2100, or vice versa. Examples of financial transactions that cross the NGO network with the interbank network include, but are not limited to: persons from the developed world depositing money into an NGO-aid-recipient's NGO account, an NGO-aid-recipient making an NGO payment card transaction outside the NGO network 1100 (e.g. at a merchant 2110 that uses an acquirer 2200 on an interbank network 2100), and/or a standard (i.e., interbank network) payment cardholder making a purchase transaction at an NGO-approved merchant 1110.

Initially, at block 4010, payment network bridge 3000 receives a cross network transaction. The cross network transaction may be initially received by the network interface 3300, which forwards the transaction to either the payment network processing engine 3112 or NGO network processing engine 3114, as is appropriate. The cross network transaction data includes: a cardholder identifier (which may be a Primary Account Number (PAN) or other unique payment card identifier), a merchant identifier, an issuer identifier, an identifier for the type of transaction taking place (a transaction type identifier), and a transaction amount. In cases where a Primary Account Number serves as the cardholder identifier, the first six digits of the PAN identifies the issuer; these six digits of the PAN are referred to as an Issuer Identification Number (IIN) or Bank Identification Number (BIN). The BIN is an issuer identifier; the issuer identifier indicates whether the issuer is on an NGO network 1100 or an interbank network 2100. Similarly, the merchant identifier indicates whether the merchant 1110/2110 (or the merchant's acquirer 2200) is on the NGO network 1100 or the interbank network 2100.

Comparison between the cardholder identifier (or issuer identifier) and the merchant identifier allows payment network bridge 3000 to determine that the transaction is a cross network transaction. It is understood that payment network merchant database 3220, NGO cardholder database 3230, and/or NGO merchant database 3240 may be consulted to determine that the transaction is a cross network transaction.

The transaction type identifier indicates whether the transaction is a purchase, a return, a cash withdrawal, a deposit, and so on.

Once identified as a cross network transaction, at block 4020, NGO-payment network interface 3116 evaluates the financial transaction and determines whether the transaction complies with the NGO payment network interface rules 3250. Typically, the NGO-payment network interface 3116 examines the type of transaction taking place (via the transaction type identifier), the transaction amount, and the parties involved in the transaction (the issuer, the merchant, and the cardholder) in making the determination. For example, in some embodiments, an interbank network cardholder or account holder may always be able to deposit value on to an NGO payment card account. In other embodiments, an NGO payment card account may be restricted to purchases from grocery stores when shopping from a non-NGO network merchant 2110. In addition to deposits and restricted merchant categories outside the NGO network, additional stipulations for cross network transactions may include:
Geographic limitations
Time limitations (e.g., time of day, time since disaster)

When the NGO-payment network interface 3116 determines that the transaction complies with the NGO payment network interface rules 3250, at decision block 4030, standard transaction processing applies, block 4040—the transaction is scored by fraud scoring engine, and forwarded on the issuer of the payment card for approval/decline. If the payment card is a standard payment card on an interbank network 2100, the transaction is forwarded to issuer 2300. When the payment card is an NGO-issued payment card on the NGO network 1100, the transaction may be forwarded to NGO 1200.

When the NGO-payment network interface 3116 determines that the transaction does not comply with the NGO payment network interface rules 3250, at decision block 4030, the transaction is automatically declined, at block 4050.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and features disclosed herein.

What is claimed is:

1. A method of processing a financial transaction, the method comprising:
receiving the financial transaction via a network interface, the financial transaction containing: a cardholder identifier, a merchant identifier, a transaction type identifier, and a transaction amount;
identifying, with a processor, that the financial transaction is a cross-network transaction from either a non-governmental organization (NGO) network to an interbank network or the interbank network to the NGO network, the identifying occurring by comparing the cardholder identifier and the merchant identifier;
retrieving, with the processor, a cross-network interface rule from a non-transitory computer-readable storage medium, the retrieval based at least in part on the cardholder identifier, the merchant identifier and the transaction type identifier;
determining, with the processor, whether the financial transaction is permitted by the cross-network interface rule;
transmitting, with the network interface, a transaction decline when the financial transaction is not permitted by the cross-network interface rule.

2. The method of claim 1 further comprising:
fraud scoring the financial transaction with the processor, resulting in a fraud score, when the financial transaction is permitted by the cross-network interface rule.

3. The method of claim 2 further comprising:
transmitting the financial transaction with the fraud score to an issuer with the network interface.

4. The method of claim 3 wherein the issuer is identified by an issuer identifier.

5. The method of claim 4 wherein the issuer identifier is encoded within the cardholder identifier.

6. The method of claim 5 wherein the issuer is the non-governmental organization.

7. The method of claim 5 wherein the issuer is a financial institution on the interbank network.

8. An apparatus to process a financial transaction, the apparatus comprising:
a network interface configured to receive the financial transaction, the financial transaction containing: a cardholder identifier, a merchant identifier, a transaction type identifier, and a transaction amount;
a processor configured to identify that the financial transaction is a cross-network transaction from either a non-governmental organization (NGO) network to an interbank network or the interbank network to the NGO network, the identifying occurring by comparing the cardholder identifier and the merchant identifier, to retrieve a cross-network interface rule from a non-transitory computer-readable storage medium, the retrieval based at least in part on the cardholder identifier, the merchant identifier and the transaction type identifier, to determine whether the financial transaction is permitted by the cross-network interface rule;
the network interface further configured to transmit a transaction decline when the financial transaction is not permitted by the cross-network interface rule.

9. The apparatus of claim 8 wherein the processor is further configured to fraud score the financial transaction, resulting in a fraud score, when the financial transaction is permitted by the cross-network interface rule.

10. The apparatus of claim 9 wherein the network interface is further configured to transmit the financial transaction with the fraud score to an issuer.

11. The apparatus of claim 10 wherein the issuer is identified by an issuer identifier.

12. The apparatus of claim 11 wherein the issuer identifier is encoded within the cardholder identifier.

13. The apparatus of claim 12 wherein the issuer is the non-governmental organization.

14. The apparatus of claim 12 wherein the issuer is a financial institution on the interbank network.

15. A non-transitory computer-readable storage medium encoded with data and instructions that when the instructions are executed by a computing device, causes the computing device to:
receive a financial transaction via a network interface, the financial transaction containing: a cardholder identifier, a merchant identifier, a transaction type identifier, and a transaction amount;
identify, with a processor, that the financial transaction is a cross-network transaction from either a non-governmental organization (NGO) network to an interbank network or the interbank network to the NGO network, the identifying occurring by comparing the cardholder identifier and the merchant identifier;
retrieve, with the processor, a cross-network interface rule from the non-transitory computer-readable storage medium, the retrieval based at least in part on the cardholder identifier, the merchant identifier and the transaction type identifier;
determine, with the processor, whether the financial transaction is permitted by the cross-network interface rule;
transmit, with the network interface, a transaction decline when the financial transaction is not permitted by the cross-network interface rule.

16. The non-transitory computer-readable storage medium of claim 15, further causing the computing device to:
fraud score the financial transaction with the processor, resulting in a fraud score, when the financial transaction is permitted by the cross-network interface rule.

17. The non-transitory computer-readable storage medium of claim 16, further causing the computing device to:
transmit, with the network interface, the financial transaction with the fraud score to an issuer.

18. The non-transitory computer-readable storage medium of claim 17, wherein the issuer is identified by an issuer identifier.

19. The non-transitory computer-readable storage medium of claim 18, wherein the issuer identifier is encoded within the cardholder identifier.

20. The non-transitory computer-readable storage medium of claim 19, wherein the issuer is the non-governmental organization.
